(19) United States
(12) Patent Application Publication
(10) Pub. No.: US 2021/0293475 A1
(43) Pub. Date: Sep. 23, 2021

(54) HELIUM CIRCULATION SYSTEM, CRYOGENIC REFRIGERATION METHOD, AND BIOMAGNETISM MEASURING APPARATUS

(71) Applicants: Shunichi MATSUMOTO, Ishikawa (JP); Kunio KAZAMI, Ishikawa (JP); Jun KONDO, Ishikawa (JP); Hiroshi KUBOTA, Ishikawa (JP); Takahiro UMENO, Tokyo (JP); Shoji TAKAMI, Tokyo (JP); Kenji IWAMOTO, Tokyo (JP); Yujiro HOTEI, Tokyo (JP)

(72) Inventors: Shunichi MATSUMOTO, Ishikawa (JP); Kunio KAZAMI, Ishikawa (JP); Jun KONDO, Ishikawa (JP); Hiroshi KUBOTA, Ishikawa (JP); Takahiro UMENO, Tokyo (JP); Shoji TAKAMI, Tokyo (JP); Kenji IWAMOTO, Tokyo (JP); Yujiro HOTEI, Tokyo (JP)

(73) Assignees: Ricoh Company, Ltd., Tokyo (JP); Taiyo Nippon Sanso Corporation, Tokyo (JP)

(21) Appl. No.: 17/208,210

(22) Filed: Mar. 22, 2021

(30) Foreign Application Priority Data
Mar. 23, 2020 (JP) 2020-051875

(51) Int. Cl. F25J 1/02; F25J 1/00

(52) U.S. Cl. CPC F25J 1/0257; F25J 1/0065

(57) ABSTRACT

A helium circulation system includes a refrigerator configured to cool a gas refrigerant into a liquid refrigerant; a first path configured to feed the liquid refrigerant from the refrigerator to a Dewar; a second path configured to feed the gas refrigerant from the Dewar to a vaporized gas collector via the refrigerator; a third path configured to feed the gas refrigerant from the vaporized gas collector to the refrigerator; a fourth path configured to feed the gas refrigerant from the Dewar to the vaporized gas collector without via the refrigerator; and a control unit configured to feed the liquid refrigerant through the first path while feeding the gas refrigerant through the third path when the refrigerator is driven, and feed the gas refrigerant through the second path while feeding the gas refrigerant the fourth path, when the refrigerator is stopped.

### CROSS-REFERENCE TO RELATED APPLICATIONS

The present application claims priority under 35 U.S.C. § 119 to Japanese Patent Application No. 2020-051875, filed on Mar. 23, 2020. The contents of which are incorporated herein by reference in their entirety.

### BACKGROUND OF THE INVENTION

### 1. Field of the Invention

The present invention relates to a helium circulation system, a cryogenic refrigeration method, and a biomagnetism measuring apparatus.

### 2. Description of the Related Art

For example, Japanese Patent No. 6602456 describes a conventional technique of reducing heat penetration by determining the diameter of a refrigerant pipe depending on its position.

A biomagnetism measuring apparatus, such as a magneto-encephalographic meter and a magneto-spinalgraphic meter, is often equipped with, for example, a high-sensitivity magnetic sensor, such as a superconducting quantum interference sensor. In such a case, in order to maintain a superconducting state, liquid helium is used as a refrigerant. A physical property measuring instrument that operates under a cryogenic environment also uses liquid helium as a refrigerant. Because liquid helium vaporizes easily, using the aforementioned measuring apparatus and instrument continuously and economically requires circulating helium using a cryogenic refrigerator.

A cryogenic refrigerator has a cooling unit (cold head) and a heat-insulting unit (cryostat) housing the cooling unit, and both units are magnetized. A pulse-tube refrigerator, which is a type of cryogenic refrigerator, generates mechanical vibration when in operation. The vibration of a magnetized apparatus or the like creates magnetic fluctuations in the surrounding space, the magnetic fluctuations being proportional to a vibrational amplitude. Such magnetic fluctuations cause the biomagnetism measuring apparatus, etc., a problem of measurement noise.

In a biomagnetism measuring apparatus, as a measure to such a problem, there is a method of stopping the cryogenic refrigerator during measurement and collecting the refrigerant during that period, while driving the cryogenic refrigerator is driven when measurement is not performed, so as to cool the collected refrigerant.

During a period in which the cryogenic refrigerator is stopped, however, its temperature rises. As a result, a time taken from the restart of the stopped cryogenic refrigerator to the start of refrigerant recondensation becomes longer. It is difficult, for this reason, to run the cryogenic refrigerator such that it performs cycles of long stoppage, for example, as daily operations. This leads to a situation where a system using a relatively small refrigerator offers an economical advantage but has a low heat exhaustion capability, requiring much time to start a helium circulation cycle. In addition, during the stoppage of the cryogenic refrigerator, the temperatures of the cooling unit and heat-insulating unit rise, creating repetitive temperature amplitudes. Exposing the cryogenic refrigerator to this repetitive temperature amplitudes, i.e., thermal shocks may lead to the breakage of the cryogenic refrigerator. It is desirable that the temperature amplitudes as thermal shocks be kept small in order to maintain the reliability of the apparatus. A linear expansion coefficient, for example, generally remains small at low temperatures lower than the liquid nitrogen temperature. Suppressing a rise in the temperature of the cooling unit is therefore desirable.

### SUMMARY OF THE INVENTION

According to an aspect of the present invention, A helium circulation system includes a refrigerator, a Dewar, a vaporized gas collector, a first path, a second path, a third path, a fourth path, and a control unit. The refrigerator is configured to cool a gas refrigerant into a liquid refrigerant. The Dewar is configured to hold the liquid refrigerant. The vaporized gas collector is configured to collect the gas refrigerant vaporized in the Dewar. The first path is configured to feed the liquid refrigerant from the refrigerator to the Dewar. The second path is configured to feed the gas refrigerant from the Dewar to the vaporized gas collector via the refrigerator. The third path is configured to feed the gas refrigerant from the vaporized gas collector to the refrigerator. The fourth path is configured to feed the gas refrigerant from the Dewar to the vaporized gas collector without via the refrigerator. The control unit is configured to feed the liquid refrigerant from the refrigerator to the Dewar through the first path while feeding the gas refrigerant from the vaporized gas collector to the refrigerator through the third path when the refrigerator is driven, and feed the gas refrigerant from the Dewar to the vaporized gas collector via the refrigerator through the second path while feeding the gas refrigerant from the Dewar to the vaporized gas collector without via the refrigerator through the fourth path, when the refrigerator is stopped.

### BRIEF DESCRIPTION OF THE DRAWINGS

FIG. 1 is a schematic configuration diagram of an example of a biomagnetism measuring apparatus;

FIG. 2 is a schematic configuration diagram of an example of a helium circulation system;

FIG. 3 is a flowchart describing operations that the helium circulation system carries out when driving a cryogenic refrigerator;

FIG. 4 is an operation chart showing operations that the helium circulation system carries out when driving the cryogenic refrigerator;

FIG. 5 is a flowchart describing operations that the helium circulation system carries out when stopping the cryogenic refrigerator; and

FIG. 6 is an operation chart showing operations that the helium circulation system carries out when stopping the cryogenic refrigerator.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of a helium circulation system, a cryogenic refrigeration method, and a biomagnetism measuring apparatus will hereinafter be described in detail with reference to the accompanying drawings.

An embodiment has an object to cool a refrigerant efficiently

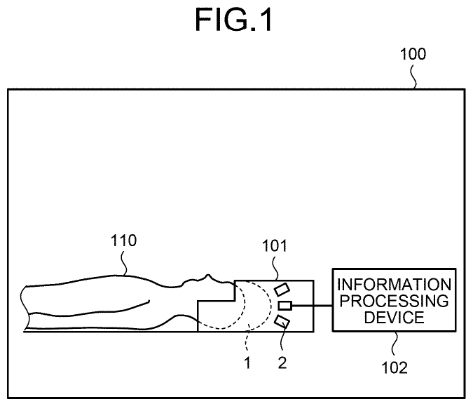

FIG. 1 is a schematic configuration diagram of an example of the biomagnetism measuring apparatus.

A biomagnetism measuring apparatus 100, which is a biodata measuring apparatus, includes a brain function measuring device 101 (which is referred to also as measuring apparatus) and an information processing device 102.

The brain function measuring device 101 is a magneto-encephalographic meter configured to measure magneto-encephalography (MEG) signals from the brain, i.e., an organ of a subject 110 who is a measurement subject. The brain function measuring device 101 has a Dewar 1 in which the head of the subject 110 is set. The Dewar 1 is a helmet-like sensor-housing Dewar that substantially encircles the entire area of the head of the subject 110. The Dewar 1 is a vacuum heat insulation apparatus that is kept in a cryogenic condition using liquid helium. Inside the Dewar 1, a number of magnetic sensors 2 for magneto-encephalographic measurement are arranged. The magnetic sensors 2 are provided as superconducting quantum interference devices (SQUID). The brain function measuring device 101 collects magneto-encephalography signals from the magnetic sensors 2, and outputs the collected magneto-encephalography signals, i.e., biosignals to the information processing device 102.

The information processing device 102 displays the waveforms of the magneto-encephalography signals from the magnetic sensors 2 along the time axis. These magneto-encephalography signals represent minute magnetic fluctuations caused by the electric activities of nerve cells (ion charge flows that are created at the dendrons of neurons when synaptic transmission takes place).

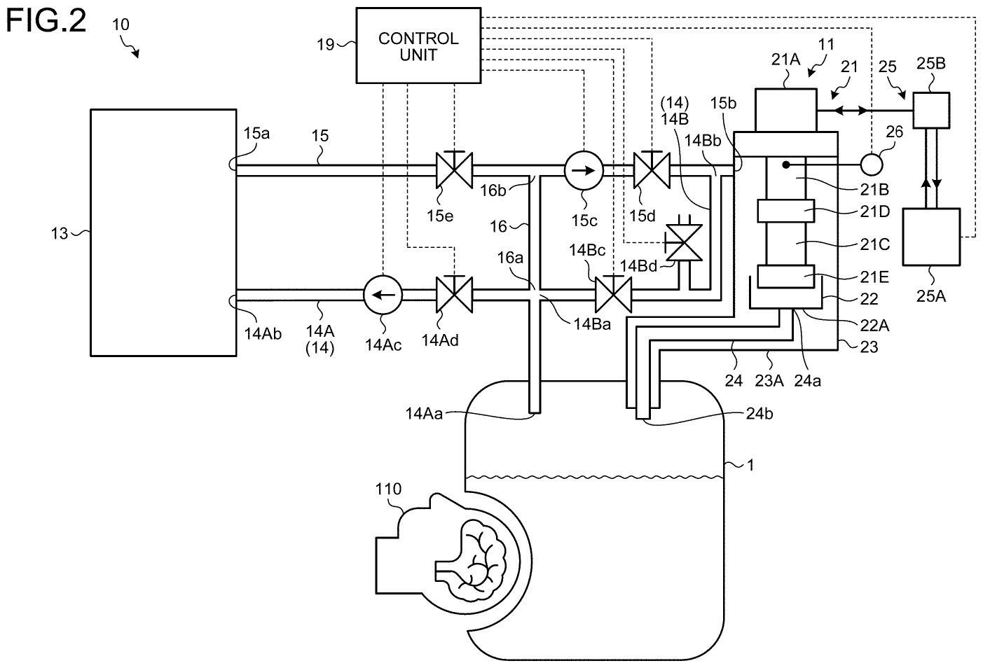

FIG. 2 is a schematic configuration diagram of an example of the helium circulation system.

The above brain function measuring device 101 includes a helium circulation system 10 configured to keep the Dewar 1, i.e., the vacuum heat insulation apparatus in a cryogenic condition. The helium circulation system 10 has a cryogenic refrigerator (refrigerator) 11, the Dewar 1, a vaporized gas collector (buffer tank) 13, a vaporized gas collecting pipe 14, a storage gas supply pipe 15, a circulation pipe 16, and a control unit 19.

The cryogenic refrigerator 11 is configured to be a pulse-tube refrigerator, and includes a cooling unit 21, a receptor 22, a heat-insulating unit 23, a transfer pipe 24, a drive system circulation unit 25, and a thermometer 26.

The cooling unit 21 has a body 21A, a first cylinder 21B of a cylindrical shape, a second cylinder 21C of a cylindrical shape, a first cold stage 21D of a disc shape, and a second cold stage 21E of a disc shape. The body 21A serves as a base of the cooling unit 21, and is placed at the top of the cooling unit 21. The first cylinder 21B extends downward from the body 21A. The second cylinder 21C is under the first cylinder 21B and extends downward from there. The first cold stage 21D is disposed between the first cylinder 21B and the second cylinder 21C. The second cold stage 21E is disposed on a lower end of the downward extending second cylinder 21C.

The receptor 22 is of a tray-like shape having an open upper end and a lower end formed as a bottom 22A. The receptor 22 is disposed underneath the cooling unit 21.

The heat-insulating unit 23 is a cryostat that maintains a vacuum heat insulation state. It is a cylindrical container made of, for example, stainless or glass fiber reinforced resin, and has an open upper end and a lower end formed as a bottom 23A. The heat-insulating unit 23 is arranged to store the cooling unit 21 therein so as to encircle the outer periphery of the cooling unit 21 with a gap. The heat-insulating unit 23 has its upper end sealed with the body 21A of the cooling unit 21. The receptor 22 is disposed inside the heat-insulating unit 23. The heat-insulating unit 23 functions in such a way as to keep its internal temperature as it is.

The transfer pipe 24 has an upper end 24a connected to the bottom 22A of the receptor 22, which allows the transfer pipe 24 to communicate with the receptor 22. The transfer pipe 24 extends downward from the bottom 22A of the receptor 22 and extends further through the interior of the heat-insulating unit 23 up to a lower end 24b, which faces downward. The heat-insulating unit 23 extends downward along with the transfer pipe 24 such that the bottom 23A encircles the outer periphery of the transfer pipe 24 across a gap. The transfer pipe 24 has its lower end 24b connected to the Dewar 1 of the brain function measuring device 101. The transfer pipe 24 is referred to also as a first path configured to feed a liquid refrigerant from the cooling unit 21 to the Dewar 1.

The drive system circulation unit 25 has a compressor 25A and a valve motor 25B, which is an operating unit. The compressor 25A compresses a gas into a compressed gas, which is, for example, a helium gas. The compressed gas created by the compressor 25A is supplied to the valve motor 25B. The valve motor 25B switches a valve open and close so as to intermittently supply the compressed gas to the body 21A of the cooling unit 21. The drive system circulation unit 25 causes the valve motor 25B to switch the valve open and close, thereby circulating the compressed gas between the compressor 25A and the cooling unit 21. Being supplied intermittently with the compressed gas, the cooling unit 21 starts up, generating cryogenic energy at the first cold stage 21D and the second cold stage 21E. The compressor 25A is exhausted of heat by a water-cooling or air-cooling method.

The thermometer 26 measures the temperature of the cooling unit 21 inside the heat-insulating unit 27.

When the cryogenic refrigerator 11 is in operation, the cooling unit 21 inside the heat-insulating unit 23 is supplied with a gas refrigerant. This gas refrigerant is, for example, a helium gas, which is cooled by cryogenic energy generated at the first cold stage 21D and the second cold stage 21E and is consequently liquidized into liquid helium, which is a liquid refrigerant. The liquid helium then reaches the bottom 22A of the receptor 22, where drops of the liquid helium are gathered. The liquid helium gathered on the bottom 22A of the receptor 22 then flows through the transfer pipe 24 to come out of the cryogenic refrigerator 11, and finally falls into a helium tank inside the Dewar 1 of the brain function measuring device 101. The liquid helium is thus held in the Dewar 1 of the brain function measuring device 101. The liquid helium inside the Dewar 1 gradually vaporizes as external heat enters the Dewar 1, thus finally turning into a helium gas (which is referred to also as vaporized gas).

The vaporized gas collector 13 is a pressure vessel configured to collect and stores a vaporized gas generated at the Dewar 1.

The vaporized gas collecting pipe 14 is a pipe connecting the Dewar 1 to the vaporized gas collector 13. The vaporized gas collecting pipe 14 has a first vaporized gas collecting pipe 14A and a second vaporized gas collecting pipe 14B.

The first vaporized gas collecting pipe 14A has one end 14Aa connected to the Dewar 1, and the other end 14Ab connected to the vaporized gas collector 13. To feed the vaporized gas from the Dewar 1 to the vaporized gas collector 13, the first vaporized gas collecting pipe 14 is provided with a pump 14Ac disposed on a middle part of the first vaporized gas collecting pipe 14, the pump 14Ac being a compressor. To open and close a vaporized gas feeding path, the first vaporized gas collecting pipe 14A is provided with a first on-off valve 14Ad disposed closer to the one end 14Aa than the pump 14Ac. The first on-off valve 14Ad is controlled by the control unit 19, and is configured as a flow rate adjusting valve. The first vaporized gas collecting pipe 14A is referred to also as a fourth path configured to feed the vaporized gas from the Dewar 1 directly to the vaporized gas collector 13.

The second vaporized gas collecting pipe 14B is a pipe connecting a middle part of the first vaporized gas collecting pipe 14A to the interior of the heat-insulating unit 23 of the cooling unit 21. The second vaporized gas collecting pipe 14B has one end 14Ba connected to a part between the one end 14Aa of the first vaporized gas collecting pipe 14A and the on-off valve 14Ad, and the other end 14Bb connected to the heat-insulating unit 23. According to this embodiment, the second vaporized gas collecting pipe 14B has the other end 14Bb connected to the heat-insulating unit 23 via a part of the storage gas supply pipe 15. To open and close a vaporized gas feeding path, the second vaporized gas collecting pipe 14B is provided with a second on-off valve 14Bc disposed on a middle part of the second vaporized gas collecting pipe 14B. The second on-off valve 14Bc is controlled by the control unit 19, and is configured as a flow rate adjusting valve. The second vaporized gas collecting pipe 14B is provided also with an exhaust valve (exhaust portion) 14Bd disposed closer to the other end 14Bb than the second on-off valve 14Bc. The exhaust valve 14Bd is controlled by the control unit 19, and is connected to the heat-insulating unit 23 via the second vaporized gas collecting pipe 14B and the part of the storage gas supply pipe 15. The second vaporized gas collecting pipe 14B is referred to also as a second path configured to feed the vaporized gas from the Dewar 1 to the vaporized gas collector 13 via the transfer pipe 24 of the cooling unit 21, the interior of the heat-insulating unit 23, and a part of the first vaporized gas collecting pipe 14A.

The storage gas supply pipe 15 is a pipe connecting the vaporized gas collector 13 to the interior of the heat-insulating unit 23 of the cooling unit 21. The storage gas supply pipe 15 has a first end 15a connected to the vaporized gas collector 13, and a second end 15b connected to the heat-insulating unit 23 of the cryogenic refrigerator 11. To feed the vaporized gas (storage gas) stored in the vaporized gas collector 13 from the vaporized gas collector 13 to the cooling unit 21, the storage gas supply pipe 15 is provided with a pump 15c disposed on a middle part of the storage gas supply pipe 15. To open and close a gas refrigerant feeding path, the storage gas supply pipe 15 is provided with an on-off valve 15d disposed closer to the second end 15b than the pump 15c. The on-off valve 15d is controlled by the control unit 19. To open and close a gas refrigerant feeding path, the storage gas supply pipe 15 is provided also with an on-off valve 15e disposed closer to the first end 15a than the pump 15c. The on-off valve 15e is controlled by the control unit 19. The storage gas supply pipe 15 is referred to also as a third path configured to feed the vaporized gas from the vaporized gas collector 13 to the cooling unit 21.

The circulation pipe 16 is a pipe connecting a middle part of the vaporized gas collecting pipe 14 to a middle part of the storage gas supply pipe 15. The circulation pipe 16 has one end 16a connected to the part between the on-off valve 14Ad and the on-off valve 14Bc of the vaporized gas collecting pipe 14, and the other end 16b connected to the part between the on-off valve 15e and the pump 15c of the storage gas supply pipe 15. The circulation pipe 16 is referred to also as a bypassing path configured to feed the vaporized gas directly from the Dewar 1 to the cooling unit 21.

The control unit 19, which controls the helium circulation system 10, is an arithmetic logical unit having a central processing unit (CPU), a memory, and the like. The control unit 19 controls operations of the compressor 25A of the cryogenic refrigerator 11, the pump 14Ac, the on-off valves 14Ad and 14Bc, and the exhaust valve 14Bd of the vaporized gas collecting pipe 14, and the pump 15c and the on-off valves 15d and 15e of the storage gas supply pipe 15. The control unit 19 acquires a temperature measured by the thermometer 26 of the cryogenic refrigerator 11. The on-off valves 14Ad and 14Bc each working as the flow rate adjusting valve of the vaporized gas collecting pipe 14 are elements of a flow rate adjusting unit configured to adjust the flow rate of the vaporized gas in the vaporized gas collecting pipe 14 when degrees of openness of the on-off valves 14Ad and 14Bc are controlled and adjusted by the control unit 19. This flow rate adjusting unit may be provided as a mass-flow controller. The pump 15c of the storage gas supply pipe 15 is an element of a flowrate control unit configured to control the flowrate of the refrigerant when the output from the pump 15c is controlled by the control unit 19.

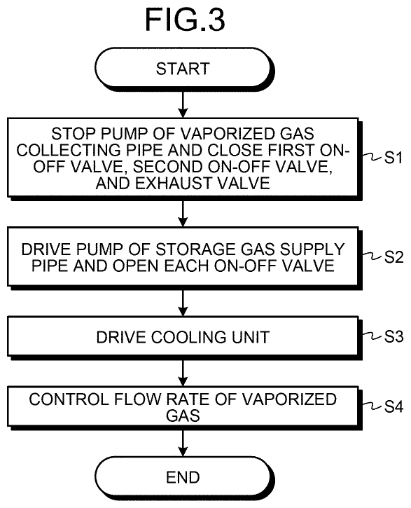

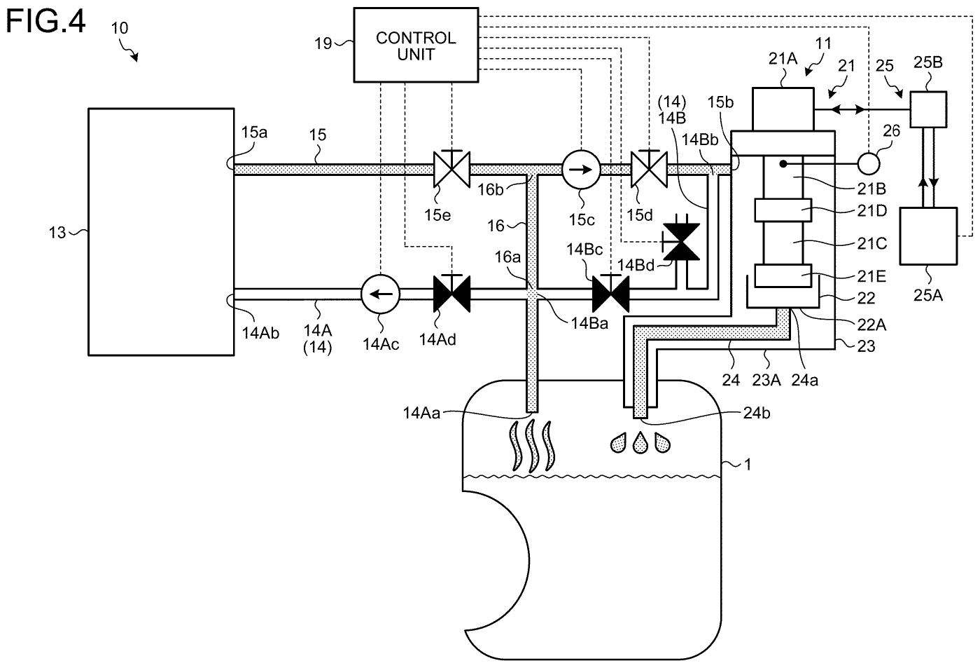

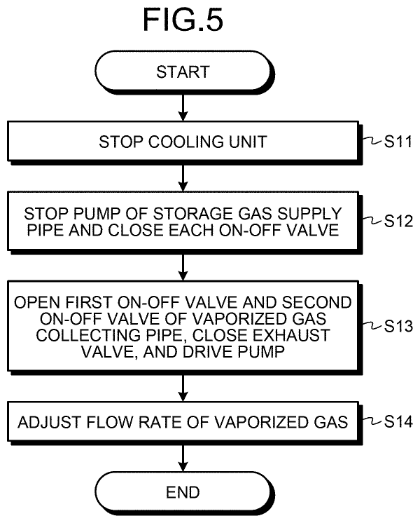

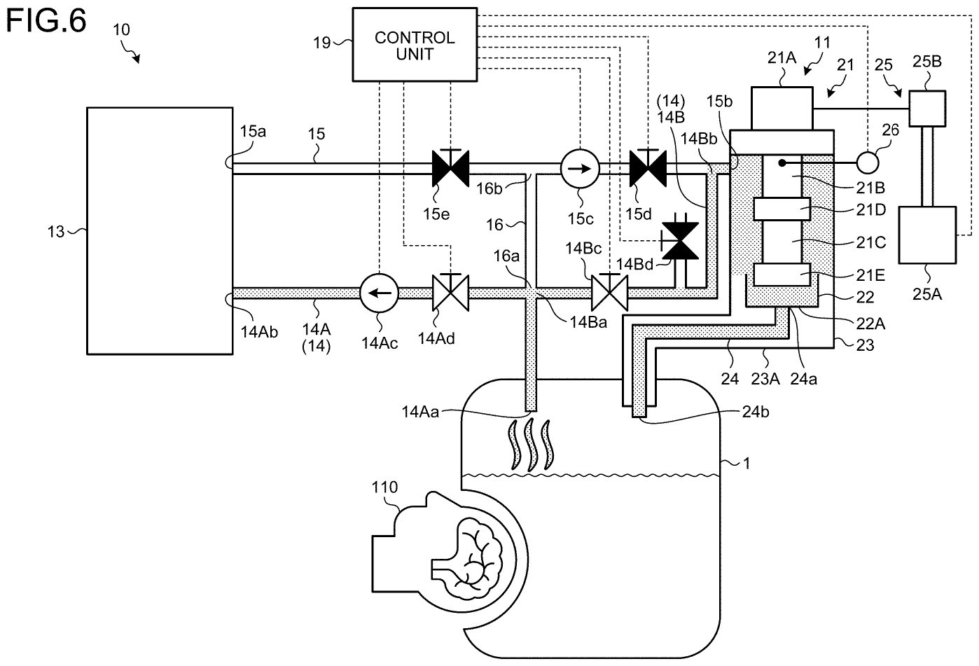

Operations of the helium circulation system 10 will now be described. FIG. 3 is a flowchart describing operations that the helium circulation system carries out when driving the cryogenic refrigerator. FIG. 4 is an operation chart showing operations that the helium circulation system carries out when driving the cryogenic refrigerator. FIG. 5 is a flowchart describing operations that the helium circulation system carries out when stopping the cryogenic refrigerator. FIG. 6 is an operation chart showing operations that the helium circulation system carries out when stopping the cryogenic refrigerator.

As shown in FIG. 3, when the cryogenic refrigerator 11 is driven, the control unit 19 stops a pump 14c of the vaporized gas collecting pipe 14 and closes the first on-off valve 14Ad, the second on-off valve 14Bc, and the exhaust valve 14Bd (step S1). At the same time, the control unit 19 drives the pump 15c of the storage gas supply pipe 15 and opens the on-off valve 15d and the on-off valve 15e (step S2). The control unit 19 then drives the cooling unit 21 of the cryogenic refrigerator 11 (step S3). As a result, as shown in FIG. 4, the helium circulation system 10 feeds a gas refrigerant from the vaporized gas collector 13 to the cooling unit 21 via the storage gas supply pipe 15, and feeds a vaporized gas from the Dewar 1 to the cooling unit 21 via a part of the first vaporized gas collecting pipe 14A of the vaporized gas collecting pipe 14 and the circulation pipe 16. The cooling unit 21 cools the vaporized gas into a liquid refrigerant and feeds it to the Dewar 1. Steps S1 to S3 may be executed simultaneously.

When the cryogenic refrigerator 11 is driven, the control unit 19 controls the pump 15c of the storage gas supply pipe 15 to adjust output from the pump 15c, thereby controlling the flow rate of the vaporized gas that is fed from the vaporized gas collector 13 to the cooling unit 21 via the storage gas supply pipe 15 (step S4).

As shown in FIG. 5, when the cryogenic refrigerator 11 is stopped, the control unit 19 stops the cooling unit 21 of the cryogenic refrigerator 11 (step S11). At the same time, the control unit 19 stops the pump 15c of the storage gas supply pipe 15 and closes the on-off valve 15d and the on-off valve 15e (step S12). In addition, the control unit 19 opens the first on-off valve 14Ad and the second on-off valve 14Bc of the vaporized gas collecting pipe 14, closes the exhaust valve 14Bd, and drives the pump 14c (step S13). As a result, as shown in FIG. 6, the helium circulation system 10 feeds the vaporized gas from the Dewar 1 to the vaporized gas collector 13 through the first vaporized gas collecting pipe 14A and the second vaporized gas collecting pipe 14B of the vaporized gas collecting pipe 14, via the transfer pipe 24 and the interior of the heat-insulating unit 23 of the cryogenic refrigerator 11, and causes the vaporized gas collector 13 to collect the vaporized gas. At the same time, the helium circulation system 10 feeds the vaporized gas from the Dewar 1 directly to the vaporized gas collector 13 through the first vaporized gas collecting pipe 14A of the vaporized gas collecting pipe 14 without via the cryogenic refrigerator 11, and collects the vaporized gas by the vaporized gas collector 13. Steps S11 to S13 may be executed simultaneously.

When the cryogenic refrigerator 11 is stopped, the control unit 19 adjusts respective degrees of openness of the on-off valves 14Ad and 14Bc, thereby adjusting the flow rate of the vaporized gas that is fed from the Dewar 1 to the vaporized gas collector 13 through the vaporized gas collecting pipe 14 via the transfer pipe 24 and the heat-insulating unit 23 of the cryogenic refrigerator 11, and adjusting the flow rate of the vaporized gas that is fed from the Dewar 1 directly to the vaporized gas collector 13 without via the cryogenic refrigerator 11 (step S14). At step S14, the control unit 19 acquires a temperature measured by the thermometer 26, and adjusts the flow rate of each flow of the vaporized gas fed to the vaporized gas collector 13, depending on the acquired temperature. For example, when a temperature measured by the thermometer 26 is equal to or higher than a given temperature, the control unit 19 makes flow rate adjustment to increase the flow rate of the flow of the vaporized gas that travels through the transfer pipe 24 and the interior of the heat-insulating unit 23 of the cryogenic refrigerator 11, thereby suppressing a temperature increase at the cooling unit 21 inside the heat-insulating unit 23. When a temperature measured by the thermometer 26 is lower than the given temperature, in contrast, the control unit 19 makes flow rate adjustment to decrease the flow rate of the flow of the gas refrigerant that travels through the cryogenic refrigerator 11, thereby suppressing a temperature increase at a section including the Dewar 1 and the first vaporized gas collecting pipe 14A.

When the brain function measuring device 101 is not used from 5 p.m. to 9 a.m. on the next day, for example, the helium circulation system 10 of this embodiment carries out the operations illustrated in FIGS. 3 and 4, thus causing the cooling unit 21 to cool the gas refrigerant into the liquid refrigerant and feed the liquid refrigerant to the Dewar 1. When the brain function measuring device 101 is used from 9 a.m. to 5 p.m., on the other hand, the helium circulation system 10 of this embodiment carries out the operations illustrated in FIGS. 5 and 6, thus causing the Dewar 1 to feed the gas refrigerant to the vaporized gas collector 13, which collects the incoming gas refrigerant. Therefore, in the helium circulation system 10 of this embodiment, the cryogenic refrigerator 11 is stopped in measurement using the brain function measuring device 101 so that it is possible to prevent vibration of the cryogenic refrigerator 11 from affecting the brain function measuring device 101 ,and the cryogenic refrigerator 11 is driven when the brain function measuring device 101 is not used for any measurement, so that it is possible to put the Dewar 1 into a cryogenic condition.

According to the helium circulation system 10 of this embodiment, the control unit 19 acquires the temperature of the cooling unit 21 that is measured by the thermometer 26. When finding that the acquired temperature is equal to or higher than the given temperature, the control unit 19 opens the exhaust valve 14Bd of the exhaust unit. Specifically, in control over the cryogenic refrigerator 11, the control unit 19 keeps the exhaust valve 14Bd closed other than such a case (see FIGS. 4 and 6). When finding a temperature measured by the thermometer 26 to be equal to or higher than the given temperature when the cooling unit 21 is stopped as shown in FIG. 6, the control unit 19 opens the exhaust valve 14Bd. The given temperature is a temperature at which an impurity component (a tiny amount of nitrogen, oxygen, moisture, or the like included in the vaporized gas) could vaporize. The cooling unit 21 being stopped means that a compressed gas is not supplied, while the cooling unit 21 being driven means that the compressed gas is supplied. When finding a temperature measured by the thermometer 26 to be not equal to or higher than the given temperature, the control unit 19 continues to acquire temperatures measured by the thermometer 26. According to this helium circulation system 10, when the impurity component vaporizes, the vaporized impurity component is discharged from the heat-insulating unit 23. The helium circulation system 10 thus prevents a case where the impurity component having been re-cooled and solidified in the transfer pipe 24 blocks the transfer pipe 24.

In this manner, the helium circulation system 10 of this embodiment includes: the cryogenic refrigerator 11 configured to cool a gas refrigerant; the Dewar 1 configured to hold a cooled liquid refrigerant; the vaporized gas collector 13 configured to collect the gas refrigerant vaporized in the Dewar 1; the transfer pipe 24 (first path) configured to feed the liquid refrigerant from the cryogenic refrigerator 11 to the Dewar 1; the transfer pipe 24, the heat-insulating unit 23, and the vaporized gas collecting pipe 14 (second path) configured to feed the gas refrigerant from the Dewar 1 to the vaporized gas collector 13 via the cryogenic refrigerator 11; the storage gas supply pipe 15 (third path) configured to feed the gas refrigerant from the vaporized gas collector 13 to the cryogenic refrigerator 11; the second vaporized gas collecting pipe 14A (fourth path) configured to feed the gas refrigerant from the Dewar 1 to the vaporized gas collector 13 without via the cryogenic refrigerator 11; and the control unit 19 configured to feed the liquid refrigerant from the cryogenic refrigerator 11 to the Dewar 1 through the transfer pipe 24 while feeding the gas refrigerant from the vaporized gas collector 13 to the cryogenic refrigerator 11 through the storage gas supply pipe 15 when the cryogenic refrigerator 11 is driven, and configured to feed the gas refrigerant from the Dewar 1 to the vaporized gas collector 13 via the cryogenic refrigerator 11 through the transfer pipe 24, the heat-insulating unit 23, and the vaporized gas collecting pipe 14 while feeding the gas refrigerant from the Dewar 1 to the vaporized gas collector 13 without via the cryogenic refrigerator 11 through the second vaporized gas collecting pipe 14A, when the cryogenic refrigerator 11 is stopped.

The cryogenic refrigeration method of this embodiment feeds the liquid refrigerant from the cryogenic refrigerator 11 to the Dewar 1 through the transfer pipe 24 while feeding the gas refrigerant from the vaporized gas collector 13 to the cryogenic refrigerator 11 through the storage gas supply pipe 15 when the cryogenic refrigerator 11 is driven, and feeds the gas refrigerant from the Dewar 1 to the vaporized gas collector 13 via the cryogenic refrigerator 11 through the feeding path including the transfer pipe 24, the heat-insulating unit 23, and the vaporized gas collecting pipe 14 while feeding the gas refrigerant from the Dewar 1 to the vaporized gas collector 13 without via the cryogenic refrigerator 11 through the second vaporized gas collecting pipe 14A, when the cryogenic refrigerator 11 is stopped.

According to the helium circulation system 10 and the cryogenic refrigeration method, when the cryogenic refrigerator 11 is stopped, the gas refrigerant is fed from the Dewar 1 to the vaporized gas collector 13 via the cryogenic refrigerator 11 through the feeding path including the transfer pipe 24, the heat-insulating unit 23, and the vaporized gas collecting pipe 14. In this process, the gas refrigerant from the Dewar 1 cools the cooling unit 21 of the cryogenic refrigerator 11 when flowing therethrough and is finally collected by the vaporized gas collector 13. In this manner, the cryogenic refrigerator 11 in its stopped state is cooled by the gas refrigerant, which suppresses a temperature increase at the cryogenic refrigerator 11. As a result, according to the helium circulation system 10 and the cryogenic refrigeration method of this embodiment, a time taken from the restart of the stopped cryogenic refrigerator 11 to the start of recondensation of the gas refrigerant can be reduced and therefore the gas refrigerant can be cooled efficiently. In addition, suppressing an increase in the temperature of the stopped cryogenic refrigerator 11 reduces a thermal shock, thus improving the reliability of repetitive cycles of start and stoppage.

The helium circulation system 10 of this embodiment includes the first vaporized gas collecting pipe 14A (fourth path) that connects between the Dewar 1 and the vaporized gas collector 13 without via the cryogenic refrigerator 11, when the cryogenic refrigerator 11 is stopped, and the on-off valves 14Ad and 14Bc serving as the flow rate adjusting unit configured to adjust the flow rate of the gas refrigerant in the first vaporized gas collecting pipe 14A, and in the transfer pipe 24, the heat-insulating unit 23, and the vaporized gas collecting pipe (second path).

According to this helium circulation system 10, a temperature increase at the section including the Dewar 1 and the first vaporized gas collecting pipe 14A and at the cryogenic refrigerator 11 can be adjusted.

The helium circulation system 10 of this embodiment includes the thermometer 26 configured to measure the temperature of the cooling unit 21 of the cryogenic refrigerator 11. The control unit 19 controls the on-off valves 14Ad and 14Bc serving as the flow rate adjusting unit, depending on a temperature measured by the thermometer 26.

According to this helium circulation system 10, controlling the on-off valves 14Ad and 14Bc depending on a temperature measured by the thermometer 26 achieves temperature-dependent flow rate adjustment of the gas refrigerant. This allows temperature increase adjustment at both Dewar 1 and cryogenic refrigerator 11.

The helium circulation system 10 of this embodiment provides the storage gas supply pipe 15 (third path) with the pump 15c serving as the flow rate control unit configured to control the flow rate of the gas refrigerant fed from the vaporized gas collector 13 to the cryogenic refrigerator 11.

According to this helium circulation system 10, by controlling the flow rate of the gas refrigerant fed from the vaporized gas collector 13 to the cryogenic refrigerator 11, an amount of recondensation of the gas refrigerant at the cryogenic refrigerator 11 can be controlled.

The biomagnetism measuring apparatus 100 of this embodiment includes the aforementioned helium circulation system 10, in which the cooling unit 21 of the cryogenic refrigerator 11 in its stopped state is cooled by the gas refrigerant collected by the vaporized gas collector 13. As a result, the biomagnetism measuring apparatus 100 of this embodiment reduces a time until the gas refrigerant recondenses, the gas refrigerant being supplied to the Dewar 1 of the brain function measuring device 101, and therefore improves operation efficiency.

According to an embodiment, the refrigerant can be cooled efficiently.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A helium circulation system comprising:
a refrigerator configured to cool a gas refrigerant into a liquid refrigerant;
a Dewar configured to hold the liquid refrigerant;
a vaporized gas collector configured to collect the gas refrigerant vaporized in the Dewar;
a first path configured to feed the liquid refrigerant from the refrigerator to the Dewar;
a second path configured to feed the gas refrigerant from the Dewar to the vaporized gas collector via the refrigerator;
a third path configured to feed the gas refrigerant from the vaporized gas collector to the refrigerator;
a fourth path configured to feed the gas refrigerant from the Dewar to the vaporized gas collector without via the refrigerator; and
a control unit configured to feed the liquid refrigerant from the refrigerator to the Dewar through the first path while feeding the gas refrigerant from the vaporized gas collector to the refrigerator through the third path when the refrigerator is driven, and feed the gas refrigerant from the Dewar to the vaporized gas collector via the refrigerator through the second path while feeding the gas refrigerant from the Dewar to the vaporized gas collector without via the refrigerator through the fourth path, when the refrigerator is stopped.

2. The helium circulation system according to claim 1, further comprising a flow rate adjusting unit configured to adjust a flow rate of the gas refrigerant in the second path and the fourth path.

3. The helium circulation system according to claim 2, further comprising a thermometer configured to measure a temperature of the refrigerator, wherein
the control unit is configured to control the flow rate adjusting unit, depending on a temperature measured by the thermometer.

4. The helium circulation system according to claim 1, further comprising, in the third path, a flow rate control unit configured to control a flow rate of the gas refrigerant fed from the vaporized gas collector to the refrigerator.

5. A biomagnetism measuring apparatus comprising:
the helium circulation system according to claim 1; and
a measuring device cooled by the liquid refrigerant fed from the refrigerator to the Dewar of the helium circulation system.

6. A cryogenic refrigeration method using a helium circulation system including:
a refrigerator configured to cool a gas refrigerant into a liquid refrigerant;
a Dewar configured to hold the liquid refrigerant;
a vaporized gas collector configured to collect the gas refrigerant vaporized in the Dewar;
a first path configured to feed the liquid refrigerant from the refrigerator to the Dewar;
a second path configured to feed the gas refrigerant from the Dewar to the vaporized gas collector via the refrigerator;
a third path configured to feed the gas refrigerant from the vaporized gas collector to the refrigerator; and
a fourth path configured to feed the gas refrigerant from the Dewar to the vaporized gas collector without via the refrigerator, the cryogenic refrigeration method comprising:
feeding the liquid refrigerant from the refrigerator to the Dewar through the first path while feeding the gas refrigerant from the vaporized gas collector to the refrigerator through the third path when the refrigerator is driven; and
feeding the gas refrigerant from the Dewar to the vaporized gas collector via the refrigerator through the second path, while feeding the gas refrigerant from the Dewar to the vaporized gas collector without via the refrigerator through the fourth path, when the refrigerator is stopped.
